(19) United States
(12) Patent Application Publication
(10) Pub. No.: US 2019/0212152 A1
(43) Pub. Date: Jul. 11, 2019

(54) MEASUREMENT DATA PROCESSING

(71) Applicant: INDOORATLAS OY, Oulu (FI)

(72) Inventors: Janne HAVERINEN, Oulu (FI); Esa RAHTU, Oulu (FI); Simo SÄRKKÄ, Vantaa (FI); Juho KANNALA, Oulu (FI); Arno SOLIN, Helsinki (FI); Ville TOLVANEN, Helsinki (FI)

(73) Assignee: INDOORATLAS OY, Oulu (FI)

(21) Appl. No.: 16/301,347

(22) PCT Filed: May 10, 2016
(86) PCT No.: PCT/FI2016/050307

§ 371 Date: Nov. 13, 2018

(51) Int. Cl. G01C 21/20; G01C 21/14; G01S 5/02

(52) U.S. Cl. CPC G01C 21/206; G01S 5/0252; G01S 5/0294; G01C 21/14

(57) ABSTRACT

A processing apparatus is caused to: 1) obtain measurement data generated by a mobile apparatus with one or more sensors during a known time period, the measurement data including a plurality of measurement samples and timing data indicating timing of measurement samples in relation to each other; 2) obtain at least one event related to the mobile apparatus, the event being associated with the measurement data so that it represents a specific time and/or a specific location during the known time period; 3) construct a spatial path of the mobile apparatus based on at least a part of the measurement data and the at least one event; and 4) associate the measurement data with the spatial path so that a measurement sample is associated with a specific point of the spatial path.

### FIELD

The invention relates to a processing apparatus, computer program code for the processing apparatus, and a method in the processing apparatus.

### BACKGROUND

Collection of measurement data by a mobile apparatus is typically performed according to a predetermined plan, advising a user of the mobile apparatus to move along a predetermined route, for example. However, especially in a crowd sourcing scenario, wherein a large number of (untrained) users collect data, movement according to a predetermined plan is not preferred. A need exists for measurement data collection so that users are free to wander without any fixed plan in a random manner.

### BRIEF DESCRIPTION

The present invention seeks to provide an improved processing apparatus, improved computer program code for the processing apparatus, and an improved method in the processing apparatus.

According to an aspect of the present invention, there is provided a processing apparatus comprising: one or more processors; and one or more memories including computer program code, the one or more memories and the computer program code configured to, with the one or more processors, cause the processing apparatus at least to: obtain measurement data generated by a mobile apparatus with one or more sensors during a known time period, the measurement data comprising a plurality of measurement samples and timing data indicating timing of measurement samples in relation to each other; obtain at least one event related to the mobile apparatus, the event being associated with the measurement data so that it represents a specific time and/or a specific location during the known time period; construct a spatial path of the mobile apparatus based on at least a part of the measurement data and the at least one event; and associate the measurement data with the spatial path so that a measurement sample is associated with a specific point of the spatial path.

According to another aspect of the present invention, there is provided a non-transitory computer-readable storage medium comprising computer program code which, when loaded into a processing apparatus causes the processing apparatus at least to: obtain measurement data generated by a mobile apparatus with one or more sensors during a known time period, the measurement data comprising a plurality of measurement samples and timing data indicating timing of measurement samples in relation to each other; obtain at least one event related to the mobile apparatus, the event being associated with the measurement data so that it represents a specific time and/or a specific location during the known time period; construct a spatial path of the mobile apparatus based on at least a part of the measurement data and the at least one event; and associate the measurement data with the spatial path so that a measurement sample is associated with a specific point of the spatial path.

According to another aspect of the present invention, there is provided a method in a processing apparatus, comprising: obtaining measurement data generated by a mobile apparatus with one or more sensors during a known time period, the measurement data comprising a plurality of measurement samples and timing data indicating timing of measurement samples in relation to each other; obtaining at least one event related to the mobile apparatus, the event being associated with the measurement data so that it represents a specific time and/or a specific location during the known time period; constructing a spatial path of the mobile apparatus based on at least a part of the measurement data and the at least one event; and associating the measurement data with the spatial path so that a measurement sample is associated with a specific point of the spatial path.

### LIST OF DRAWINGS

Example embodiments of the present invention are described below, by way of example only, with reference to the accompanying drawings, in which

FIGS. 1, 2, 3 and 4 illustrate example embodiments of a processing apparatus;

FIGS. 5, 6, 7, 8 and 9 illustrate example embodiments of measurement data processing;

FIGS. 10, 11, 12, 13, 14, 15 and 16 illustrate example embodiments of measurement data manipulation in a user interface of a mobile apparatus; and

FIG. 17 is a flow chart illustrating example embodiments of a method.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

It should be noted that while Figures illustrate various embodiments of apparatuses, they are simplified block diagrams that only show some structures and functional entities. The connections shown in these Figures are logical connections; the actual physical connections may be different. Interfaces between the various elements may be implemented with suitable interface technologies, such as a message interface, a method interface, a sub-routine call interface, a block interface, or any hardware/software means enabling communication between functional sub-units. It is apparent to a person skilled in the art that the described apparatuses may also comprise other functions and structures. It should be appreciated that details of some functions, structures, and the protocols used for communication are irrelevant to the actual invention. Therefore, they need not be discussed in more detail here.

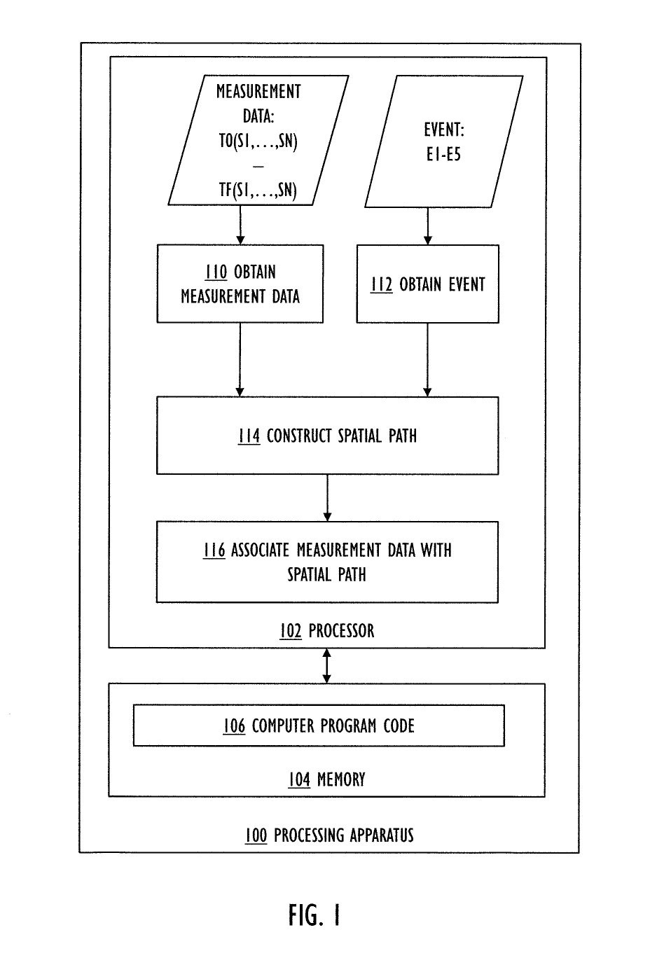

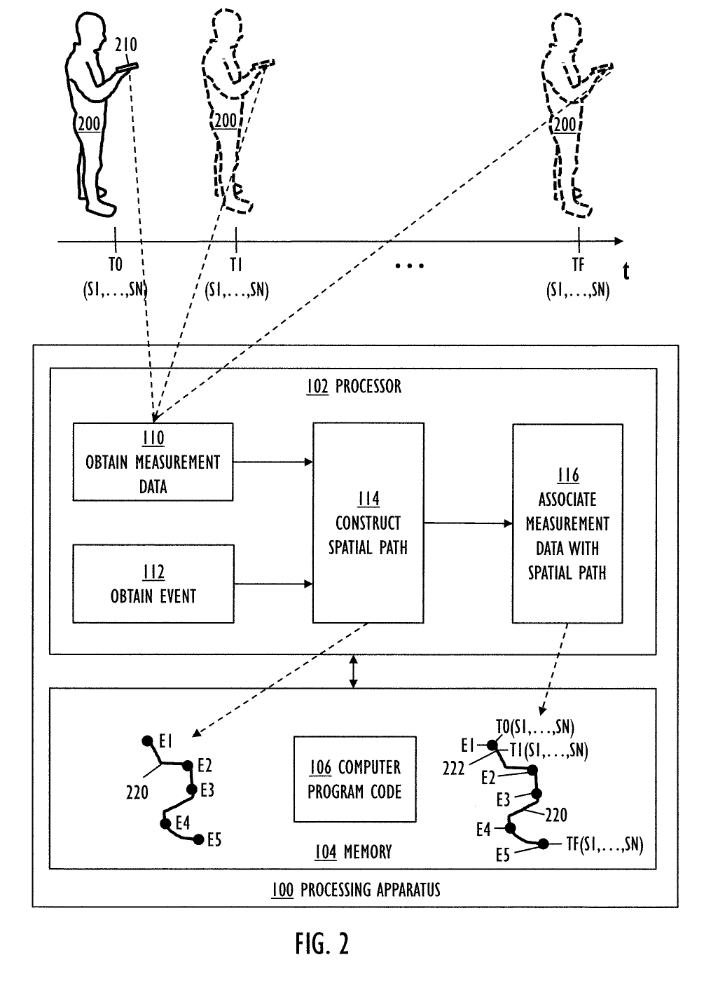

FIGS. 1 and 2 illustrate example embodiments of a processing apparatus 100.

The processing apparatus 100 comprises one or more processors 102, and one or more memories 104 including computer program code 106.

The term ‘processor’ 102 refers to a device that is capable of processing data. Depending on the processing power needed, the processing apparatus 100 may comprise several processors 102 such as parallel processors or a multicore processor. When designing the implementation of the processor 102, a person skilled in the art will consider the requirements set for the size and power consumption of the processing apparatus 100, the necessary processing capacity, production costs, and production volumes, for example. The processor 102 and the memory 104 may be implemented by an electronic circuitry.

The term ‘memory’ 104 refers to a device that is capable of storing data run-time (=working memory) or permanently (=non-volatile memory). The working memory and the non-volatile memory may be implemented by a random-access memory (RAM), dynamic RAM (DRAM), static RAM (SRAM), a flash memory, a solid state disk (SSD), PROM (programmable read-only memory), a suitable semiconductor, or any other means of implementing an electrical computer memory.

The computer program code 106 may be implemented by software and/or hardware. In an example embodiment, the software may be written by a suitable programming language, and the resulting executable code 106 may be stored on the memory 104 and run by the processor 102. In an alternative example embodiment, the functionality of the hardware may be designed by a suitable hardware description language (such as Verilog or VHDL), and transformed into a gate-level netlist (describing standard cells and the electrical connections between them), and after further phases the chip implementing the processor 102, memory 104 and the code 106 of the processing apparatus 100 may be fabricated with photo masks describing the circuitry.

The one or more memories 104 and the computer program code 106 are configured to, with the one or more processors 102, cause the processing apparatus 100 at least to perform the following four operations, see also FIG. 2:

110) obtain measurement data T0(S1, . . . , SN)-TF(S1, . . . , SN) generated by a mobile apparatus 210 with one or more sensors S1-SN during a known time period T0-TF, the measurement data T0(S1, . . . , SN)-TF(S1, . . . , SN) comprising a plurality of measurement samples and timing data indicating timing of measurement samples in relation to each other.

112) obtain at least one event E1-E5 related to the mobile apparatus 210, the event E1-E5 being associated with the measurement data T0(S1, . . . , SN)-TF(S1, . . . , SN) so that it represents a specific time and/or a specific location during the known time period T0-TF.

114) construct a spatial path 220 of the mobile apparatus 210 based on at least a part of the measurement data T0(S1, . . . , SN)-TF(S1, . . . , SN) and the at least one event E1-E5.

116) associate the measurement data T0(S1, . . . , SN)-TF(S1, . . . , SN) with the spatial path 220 so that a measurement sample T0(S1, . . . , SN), T1(S1, . . . , SN), TF(S1, . . . , SN) is associated with a specific point W1, 222, W5 of the spatial path 220.

Note that in the described example embodiment the number of different sensors may vary from 1 to N, wherein N is any integer greater than one, and T0 (“T zero”) is the starting time and TF (“T final”) the ending time. The measurement timing of each sensor is not necessarily synchronized with each other, i.e. at any given time T0, T1, . . . , TF the timing between various sensors S1-SN may vary. For example, at time T1 the sensor 1 produces a measurement sample, at time T1−1 ms the sensor 2 produces a measurement sample, and at time T1+2 ms the sensor 3 produces a measurement sample. Depending on the measurement interval, the measurement samples are tied to a single point in time, in our example, all three sensor values are assigned as follows: T1(S1, S2, S3). The measurement interval may vary considerably (in a typical scenario from less than 1 Hz to 200 Hz, for example). The timing differences between various sensors S1-SN may be caused by the delays in connections between sensors S1-SN and the processor 102, local processing in the sensor S1-SN, and other factors caused by a distributed sensor configuration.

In an example embodiment, the measurement period T0-TF is a part of a longer period during which sensors S1, . . . , SN are active.

Timing data indicating timing of measurements may be implemented by time-stamping the measurement samples, or by performing the measurements at a predetermined frequency, for example.

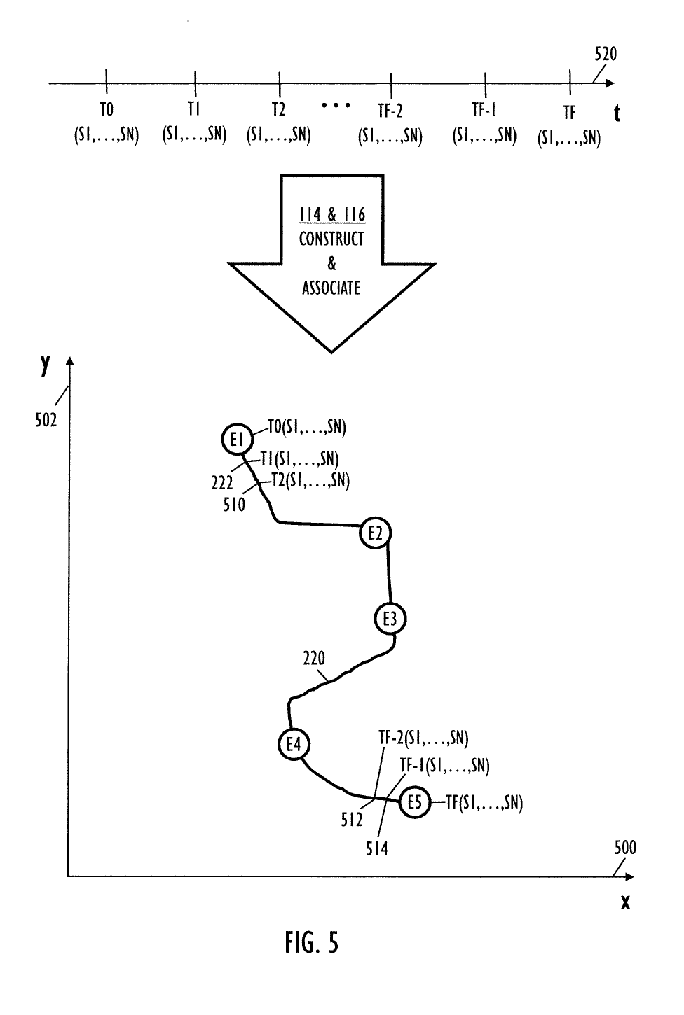

FIG. 5 illustrates an example embodiment in more detail: the measurement data T0(S1, . . . , SN), T1(S1, . . . , SN), T2(S1, . . . , SN), . . . , TF-2(S1, . . . , SN), TF-1(S1, . . . , SN), TF(S1, . . . , SN) measured and collected during a known time period, i.e., in time domain 520, is transformed, with the construction of the spatial path 220 based on the at least a part of the measurement data T0(S1, . . . , SN), T1(S1, . . . , SN), T2(S1, . . . , SN), . . . , TF-2(S1, . . . , SN), TF-1(S1, . . . , SN), TF(S1, . . . , SN) and the obtained events E1, E2, E3, E4, E5, and with the association of the measurement data T0(S1, . . . , SN), T1(S1, . . . , SN), T2(S1, . . . , SN), . . . , TF-2(S1, . . . , SN), TF-1(S1, . . . , SN), TF(S1, . . . , SN) with the spatial path 220, into space domain, which may be defined in at least two dimensions, with an x axis 500 and an y axis 502. In an example embodiment, the space domain may be defined with at least two-dimensional map (or with a three-dimensional map).

In an example embodiment, the at least one event E1-E5 related to the mobile apparatus 210 further comprises at least one of a speed of the mobile apparatus 210, a heading of the mobile apparatus 210, a loop closure of the spatial path 220. In an alternative, or additional, example embodiment, the at least one event E1-E5 related to the mobile apparatus 210 further comprises a waypoint W with a set of coordinates determining the specific location (in a physical space). The set of the coordinates may include longitude and latitude (and possibly also altitude). The waypoint may be relate to a distinctive feature of the real world, such as a building entrance, a specific location in a building, etc., but it may also relate to a physical artifacts created specifically for navigation, such as a radio beacon, control points etc.

In an example embodiment, a quality value is defined for the event E1-E5 by the processing apparatus 100. The quality value of the event E1-E5 may determine, for example, that the event E1-E5 is very reliable (with a specific scale, such as from 1% to 100%, or with a variance, for example). The quality value may be generated by the processing apparatus 100 automatically, or by a user interface operation (the user may indicate that s/he is at a specific building entrance for sure, for example, whereby the obtained waypoint is considered reliable). The quality value may be utilized in the construction 114 of the spatial path 220: the more reliable the event E1-E5, the more weight it is given in the construction 114 algorithm. The quality value may also be based on an evaluation of the sensor E1-E5: the more advanced the sensor S1-SN, the higher the quality value, for example.

In an example embodiment, the construction 114 of the spatial path 220 utilizes dead reckoning, which refers to navigation in which a current position of the mobile apparatus 210 is calculated by using a previously determined position, fix, and advancing that position based on a determined speed over elapsed time and course. The speed and the course may be determined with various ways, such as by inertial measurement data (such as acceleration data and/or gyroscope data). If the mobile apparatus 210 is carried around by a pedestrian, pedestrian dead reckoning (PDR) may be used for the construction 114 of the spatial path 220, with all of its finesses (such as the use of step detection, cadence, and direction, all of which may be detected with a pedometer or an acceleration sensor, for example). Also other measurements may be utilized (such as speedometer, milometer and steering direction data provided that the mobile apparatus 210 is coupled with a vehicle). The spatial path 220 may be the determined course or a plurality of determined successive positions. Positions and events may also be determined with other types of sensor data, with radio frequency based positioning utilizing the so-called triangulation (with reception power information of two or more base stations, for example), for example, and other ways of recognizing a position from among known positions (such as camera-based positioning, for example). The location may be determined with an accuracy that may vary: the known location may be very accurate, within an error margin of a few meters, or less accurate, such as being specific to a certain area (possibly having some radius like 100 meters or less or more, for example).

In an example embodiment, the position may be determined based on an identifier of an access point (utilizing WiFi, for example). The identifier may be e.g. service set identifier (SSID) or a basic service set identifier (BSSID), both of which may identify the access point transmitting the RF signal, such as the WiFi signal. This may indicate the location of the access point and thereby indicate the location of the mobile apparatus 210 receiving the WiFi signal. There may be several access points in the building and it may be possible to identify the floor of the mobile apparatus 210 based on the identifier.

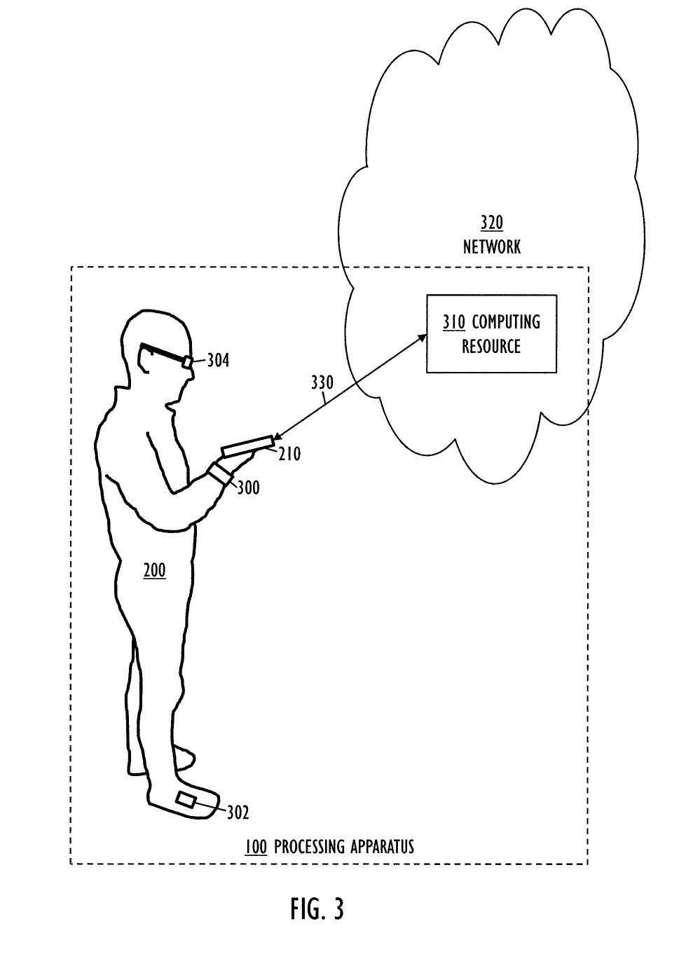

In an example embodiment, illustrated in FIG. 3, the processing apparatus 100 comprises at least one of the following: the mobile apparatus 210, a combination of the mobile apparatus 210 and at least one other apparatus 300, 302, 304 communicatively couplable with the mobile apparatus 210, and/or a computing resource 310, which is communicatively couplable 330 with the mobile apparatus 210. This means that the functionality of the processing apparatus 100 may be centralized in one apparatus, such as in the mobile apparatus 210 or in the computing resource 310, or distributed between a plurality of intercommunicating apparatuses 210, 300, 302, 304, 310.

In an example embodiment, the mobile apparatus 210 is a portable electronic communication apparatus. A non-exhaustive list of the types of the mobile apparatus 210 includes: a mobile phone, a smartphone, a tablet computer, a phablet, a smartwatch, a general-purpose mobile computing device. In an example embodiment, the mobile apparatus 210 is a general-purpose off-the-shelf computing device, as opposed to a purpose-build proprietary equipment, whereby research & development costs will be lower as only the special-purpose software (and not the hardware) needs to be designed, implemented and tested. In FIGS. 2 and 3, an example embodiment of the mobile apparatus 210 is illustrated: the mobile apparatus 210 is a smartphone or a tablet employing a display. Such devices may employ a suitable operating system such as iOS, Android, or Windows Phone, for example. The other apparatus, communicatively couplable with the mobile apparatus 210 may be a smartwatch 300, a footpod 302, smartglasses 304, or any other apparatus accommodating at least one sensor capable of producing the measurement data T0(S1, . . . , SN)-TF(S1, . . . , SN).

Also such example embodiment is feasible, wherein the mobile apparatus 210 is a part of or is fixed to another type of apparatus capable of moving along the spatial path 220, such as a trolley, a mining vehicle, a robot, an automated guided vehicle, a submersible etc.

In an example embodiment, the computing resource 310 may be implemented as a single server computer or as a cluster of computers. The server is a part of the client-server computing model that acts as distributed application which partitions tasks or workloads between the provider of a resource or service, called server, and the service requester, called client. The server 310 may serve a number of mobile apparatuses 210. The server computer 310 may be a host that is running one or more server programs which share their resources with clients 210. The client 210 may request a service function relating to the magnetic positioning from the server 310. Also, the client 210 may initiate a communication session with the server 310 which awaits incoming requests.

In an example embodiment, the computing resource 310 may also operate according to the cloud computing model, at least in part. Naturally, besides these example embodiments of the computing resource 310, other feasible computing architectures may be utilized as well to implement the hardware and software of the computing resource 310. Consequently, besides operating according to the client/server architecture, push technology may be utilized as well. In push technology, the request for a transaction is initiated by the computing resource 310, whereas with the pull technology the request for the information is initiated by the client 210.

In an example embodiment, illustrated in FIG. 3, the computing resource 310 may be accessible through a communication network 320. In an example embodiment, the communication network 320 comprises at least one of a wireless local area network base station, an indoor base station, an access point, a wireless hot-spot, all of which may provide Internet access of the computing resource 310 through the use of a router connected to a link to an Internet service provider. In an example embodiment, the communication network 320 comprises a wireless standard/non-standard/proprietary cellular communication network such as any mobile phone network. In an example embodiment, the communication network 320 comprises a wired standard/non-standard/proprietary connection (such as Ethernet or USB), whereby the mobile apparatus 210 may sporadically, be coupled in a wired fashion with the communication network 320, and possibly also with the computing resource 310.

In an example embodiment, the wireless communication network 320 comprises any mobile phone network, regardless of the generation (such as 2G, 3G, 4G, beyond 4G, 5G etc.) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), Mobile WiMAX, and other radio systems (in their present forms and/or in their evolution forms).

In an example embodiment, the communication network 320 supports the use of subscriber identity module (SIM), which may be an integrated circuit storing subscriber data, which is network-specific information used to authenticate and identify the subscriber on the cellular network. The subscriber+identity module may be embedded into a removable SIM card. Consequently, the mobile apparatus 210 may include the SIM card (and a SIM card reader). Alternatively, the mobile apparatus 210 may include a virtual or software SIM card.

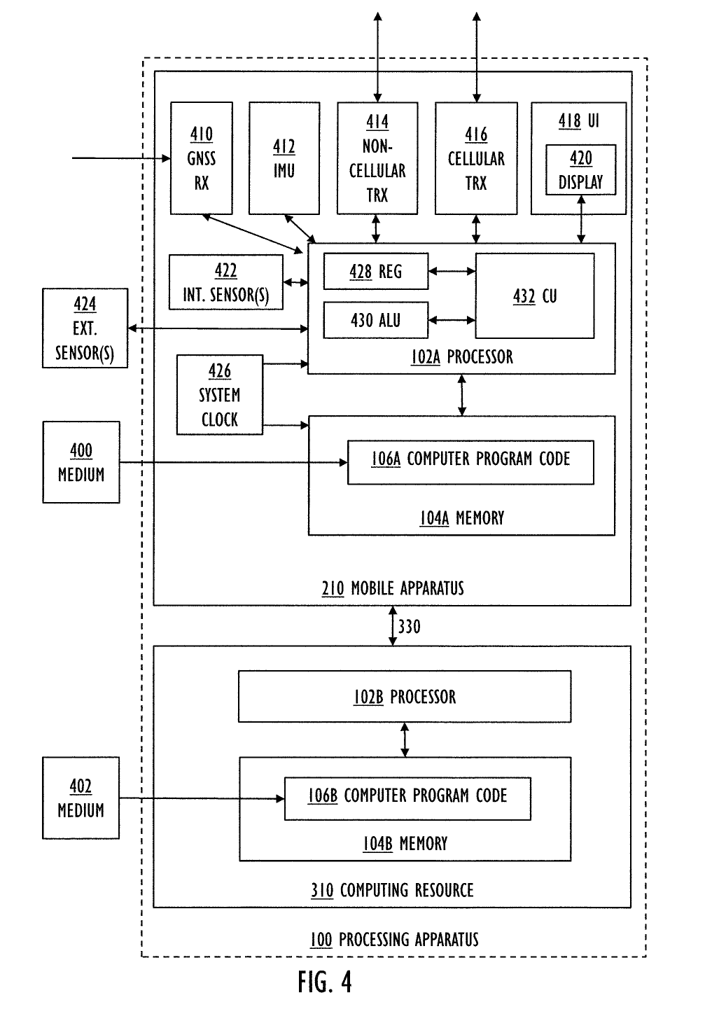

In essence, FIG. 3 illustrates an example embodiment, wherein the functionality of the processing apparatus 100 may be implemented in a centralized fashion, even in a single apparatus, or in a distributed fashion, even in a number of communicatively couplable separate apparatuses. FIG. 4 illustrates an example embodiment, wherein the processing apparatus 100 comprises the mobile apparatus 210 and the computing resource 310. Both apparatuses 210, 310 comprise one or more processors 102A, 102B, one or more memories 104A, 104B, and the (distributed) computer program code 106A, 106B.

In an example embodiment, the mobile apparatus 210 comprises a display 420. In an example embodiment, the display 420 is implemented by an appropriate technology, such as a liquid crystal display (LCD), a thin-film transistor (TFT) display, a light-emitting diode (LED) display, an organic LED (OLED) display, an electroluminescent display (ELD), or an electronic paper (or e-paper or electronic ink) display, for example. The display 420 may also incorporate other user interaction means, such as touch input, or haptic feedback, i.e. the display may be a multi-touch display 420.

In an example embodiment, the display 420 may be a part of the user interface 418 implementing the exchange of graphical, textual and/or auditory information with a user. The user interface 418 may be realized with various techniques, such as the display 420, means for producing sound, a keyboard, and/or a keypad, for example. The means for producing sound may be a loudspeaker or a simpler means for producing beeps or other sound signals. The keyboard/keypad may comprise a complete (QWERTY) keyboard, a mere numeric keypad or only a few push buttons and/or rotary buttons. In addition, or alternatively, the user interface 418 may comprise other user interface components, for example various means for focusing a cursor (mouse, track ball, arrow keys, touch sensitive area etc.) or elements enabling audio control.

In an example embodiment, the mobile apparatus 210 comprises a GNSS (Global Navigation Satellite System) receiver 410, which generates the location data on the basis of signals received from Earth-orbiting satellites. The GNSS may be GPS (Global Positioning System) of the USA, Galileo of the European Union, GLONASS of Russia, Beidou of China, or IRNSS of India, for example. Besides GNSS, or instead of GNSS, other location techniques may be utilizes as well such as those developed for use in cellular radio networks, and, consequently, the location data may be obtained from the cellular radio network.

In an example embodiment, the mobile apparatus 210 comprises inertial measurement unit 412, which generates the location data. The inertial measurement unit 412 may comprise a magnetometer to measure variations in the magnetic field caused by building structures (especially by steel frames and steel-reinforced concrete). Furthermore, the inertial measurement unit 412 may comprise an acceleration sensor (measuring in one, two or three dimensions) and/or a gyroscope, for example. It is to be noted that the inertial measurement unit 412 and software 106A may co-operate with the computing resource 310 in order to implement the positioning.

In an example embodiment, the mobile apparatus 210 comprises a cellular radio transceiver 416 and/or a non-cellular radio transceiver 414. The location data may be obtained/generated on the basis of the wireless communication utilizing the transceivers 414 and/or 416.

In an example embodiment, the cellular radio transceiver 416 may be interoperable with the already-mentioned various wireless standard/non-standard/proprietary cellular communication network 320.

In an example embodiment, the non-cellular radio transceiver 414 may utilize a short-range radio transceiver such as a Bluetooth, Bluetooth low energy (BLE), Wi-Fi (or WiFi) or other WLAN (Wireless Local Area Network) transceiver (based on IEEE (Institute of Electrical and Electronics Engineers) 802.11 standard or its evolution versions (IEEE 802.11ac etc.), for example).

The location data may also be obtained with some other means. In an example embodiment, the mobile apparatus 210 may comprise a short range wireless reader configured to read the location data from a tag attached fixedly to a known location. The short range wireless radio reader may operate utilizing electric and/or magnetic fields, such as radio frequency identification (RFID) or near-field communication (NFC), for example In an example embodiment, the mobile apparatus 210 comprises a camera, and the location data may be obtained by photographing a machine readable code (such as a barcode or a QR code) attached fixedly to a known location or by photographing or recording video (from a floor, walls and/or ceiling) and identifying the location from identified unique features. In an example embodiment, the mobile apparatus 210 comprises a depth camera (possibly with infrared technology) as the sensor S, and the resulting three-dimensional images may be utilized in the obtainment 112 of the events E1-E5, and/or in the construction 114 of the spatial path 220. On the basis of the images, additional event data may be generated such as the speed of the mobile apparatus 210.

In an example embodiment, a system clock 426 constantly generates a stream of electrical pulses, which cause the various transferring operations within the mobile apparatus 210 to take place in an orderly manner and with specific timing. The system clock 426 may be utilized to provide the timing data for the measurement data T0(S1, . . . , SN)-TF(S1, . . . , SN).

Naturally, the mobile apparatus 210 may include various other parts, such as a battery, a camera, or a radio-frequency identifier reader etc. Similarly, the computing resource 310 may comprise other parts and functionalities.

In an example embodiment, the processor 102A (and also 102B) may be implemented as a microprocessor implementing functions of a central processing unit (CPU) on an integrated circuit. The CPU is a logic machine executing the computer program code 106A. The computer program code 106A may be coded as a computer program using a programming language, which may be a high-level programming language, such as C, C++, or Java, or a low-level programming language, such as a machine language, or an assembler, for example. The CPU may comprise a set of registers 428, an arithmetic logic unit (ALU) 430, and a control unit (CU) 432. The control unit 432 is controlled by a sequence of the computer program code 106A transferred to the CPU from the (working) memory 104A. The control unit 432 may contain a number of microinstructions for basic operations. The implementation of the microinstructions may vary, depending on the CPU design. The microprocessor 102A may also have an operating system (a dedicated operating system of an embedded system, a real-time operating system, or even a general-purpose operating system), which may provide the computer program code 106A with system services.

A non-exhaustive list of implementation techniques for the processor 102A and the memory 104A includes, but is not limited to: logic components, standard integrated circuits, application-specific integrated circuits (ASIC), system-on-a-chip (SoC), application-specific standard products (ASSP), microprocessors, microcontrollers, digital signal processors, special-purpose computer chips, field-programmable gate arrays (FPGA), and other suitable electronics structures.

In an example embodiment, the processor 102A and the memory 104A are separate entities, communicatively coupled together by an appropriate serial bus, for example. In general interfaces between the various elements may be implemented with suitable interface technologies, such as a message interface, a method interface, a sub-routine call interface, a block interface, an appropriate serial/parallel bus, or any hardware/software means enabling communication between various sub-units of the mobile apparatus 210.

An example embodiment provides a computer-readable medium 400, 402 comprising the computer program code 106A, 106B which, when loaded into the processing apparatus 100 causes the processing apparatus 100 to implement the described example embodiments.

The example embodiments of the processing apparatus 100 may be used to enhance the operation of the computer program code 106. There are many ways to structure the computer program code 106. In an example embodiment, the operations of the computer program code 106 may be divided into functional modules, sub-routines, methods, classes, objects, applets, macros, etc., depending on the software design methodology and the programming language used. In modern programming environments, there are software libraries, i.e. compilations of ready-made functions, which may be utilized by the computer program code 106 for performing a wide variety of standard operations. In an example embodiment, the computer program code 106 may be in source code form, object code form, executable file, or in some intermediate form. The computer-readable medium 400, 402 may comprise at least the following: any entity or device capable of carrying computer program code 108 to the positioning management apparatus 100, a record medium, a computer memory, a read-only memory, an electrical carrier signal, a telecommunications signal, and a software distribution medium. In some jurisdictions, depending on the legislation and the patent practice, the computer-readable medium 400, 402 may not be the telecommunications signal. In an example embodiment, the computer-readable medium 400, 402 may be a non-transitory computer-readable storage medium.

In an example embodiment, the measurement data T0(S1, . . . , SN)-TF(S1, . . . , SN) comprises at least one of the following: inertial sensor data, magnetometer data, indoor base station data, cellular network data, wireless access point data, WiFi data, Bluetooth radio data, air pressure data, illumination data, audio data, video data, camera data, temperature data, barometer data, altitude data, range sensor data, indoor positioning data, global navigation satellite system data, smell sensor data, air quality sensor data, radar data, data generated by an internal sensor 422 of the mobile apparatus 210, data generated by a sensor 424 external to the mobile apparatus 210. These types of the measurement data T0(S1, . . . , SN)-TF(S1, . . . , SN) may, in general, be detected as changes in an environment surrounding the sensor S1-SN, and then the sensor S1-SN provides a corresponding output. The measurement data may also be indirect data, i.e., data produced by further processing of sensor raw data. This means that the sensor(s) S1-SN in general may comprise data processing capabilities. Further, the raw measurement data and/or processed information may be processed by the processing apparatus 100, such as in the mobile apparatus 210 and/or transmitted to the computing resource 310. The external sensor 424 may sense a specific condition, such as a specific condition in a social media environment, or it may also be a network-based sensor (being a part of Internet of Things, for example), capable of sensing information relating to the mobile apparatus 210 and its environment.

In an example embodiment, the measurement data T0(S1, . . . , SN)-TF(S1, . . . , SN) comprises inertial measurement data comprising at least one of the following: motion sensor data, acceleration sensor data, angular velocity data, stride information data.

In an example embodiment, the measurement data T0(S1, . . . , SN)-TF(S1, . . . , SN) comprises foot sensor 302 motion data.

In an example embodiment, the measurement data T0(S1, . . . , SN)-TF(S1, . . . , SN) comprises successive measurement samples of magnetic field, and the measurement data T0(S1, . . . , SN)-TF(S1, . . . , SN) is associated with the spatial path 220 so that the successive measurement samples T0(S1, . . . , SN), T1(S1, . . . , SN) of magnetic field are associated with successive specific points E1, 222 of the spatial path 220.

The Applicant, IndoorAtlas, has developed many improvements for the magnetic positioning utilizing the measurements of magnetic field, disclosed in its various patents/applications, incorporated herein by reference: U.S. Pat. Nos. 8,798,924, 9,078,104, 9,080,874, 9,151,621, 9,154,914, 9,253,601, Ser. Nos. 13/871,612, 13/905,655, 13/915,016, 14/054,264, 14/093,250, 14/207,916, 14/299,582, 14/524,420, 14/626,217, 14/725,452, 14/725,521, 14/837,678, 14/853,576, 14/859,985, 14/996,864, 14/978,148 and 15/074,085.

Steel structures (such as steel-frames or steel-reinforced concrete, for example) cause magnetic interferences indoors (such as in buildings, mines, subways, train stations, airports, harbors, particle accelerators, and other structures above ground or underground). The disturbances inside are consistent, creating a magnetic fingerprint unique to a specific location. The measurement data T0(S1, . . . , SN)-TF(S1, . . . , SN) may thus comprise successive measurement samples of magnetic field disturbed by man-made or man-formed structures (or even natural structures such as an ore containing metal in a mine). The measured magnetic field may be the Earth's magnetic field disturbed by the various structures, or even, in some cases, a powerful magnetic field created by the various structures.

In an example embodiment, the measurement data T0(S1, . . . , SN)-TF(S1, . . . , SN) comprises other sensor data besides the magnetic field, and at least a part of the other sensor data is utilized in the construction 114 of the spatial path 220. As was explained earlier, such other sensor data may comprise inertial measurement data, speedometer, milometer and steering direction data. The other sensor data may also comprise one or more of the following: inertial sensor data, indoor base station data, cellular network data, wireless access point data, WiFi data, Bluetooth radio data, air pressure data, illumination data, audio data, video data, camera data, temperature data, barometer data, altitude data, range sensor data, indoor positioning data, global navigation satellite system data, smell sensor data, air quality sensor data, data generated by an internal sensor 422 of the mobile apparatus 210, data generated by a sensor 424 external to the mobile apparatus 210. The other sensor data may aid the construction 114 of the spatial path (also by the dead reckoning), by identifying a previously determined position, an event, and/or a course, for example.

In an example embodiment, the obtainment 110 of the measurement data T0(S1, . . . , SN)-TF(S1, . . . , SN) is started from the first obtained event E1. With this example embodiment, the measurements are mapped to the event right from the start, which may make it possible to avoid futile measurements.

In an example embodiment, illustrated in FIGS. 6 and 7, the waypoint W1, W2, W3, W4, W5 is generated based on a predetermined waypoint C, which has been determined before the obtainment 110 of the measurement data T0(S1, . . . , SN)-TF(S1, . . . , SN). In a further example embodiment, the predetermined waypoint C is associated with a location on a spatial at least two-dimensional map 600. FIG. 6 illustrates predetermined waypoints C on the two-dimensional map 600, whereas FIG. 7 illustrates the obtained waypoints W1, W2, W3, W4, W5, based on the predetermined waypoints C, on the two-dimensional map 600. Note that the mobile apparatus 210 has passed through some other predetermined waypoints on its spatial path 220, but these have not been detected. In an example embodiment, the at least two-dimensional map 600 may be a floorplan of a building or other layout of a man-made structure.

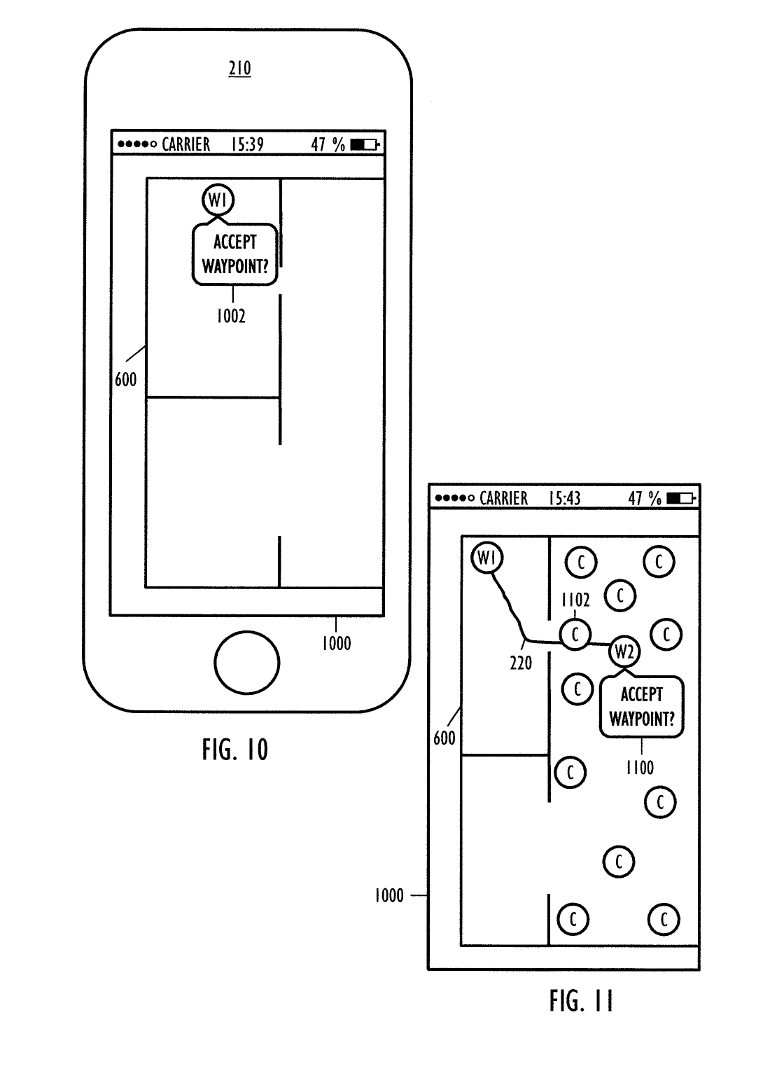

In an example embodiment illustrated in FIG. 10, the waypoint W1 is generated during the known time period by a user interface operation 1002 coupled with the mobile apparatus 210. For example: the user 200 may set the waypoint W1 with the user interface 418 of the mobile apparatus 210. In a further example embodiment, the user interface operation comprises a manipulation of a touchscreen 420, 1000.

In an example embodiment illustrated in FIG. 11, the waypoint W2 is selected from a set of predetermined waypoints C so that the waypoint W2 that is closest to the estimated location of the mobile apparatus 210 on the spatial path 220 is selected. As shown in FIG. 11, the waypoint W2 may require user interface confirmation 1100, or, alternatively, the waypoint W2 may be selected automatically, without user interaction.

In an example embodiment, the waypoint W2 is selected from a set of predetermined waypoints C so that the waypoint whose corresponding measurement data best matches a predetermined condition defined for the waypoint is selected. For example, it may have been defined that in waypoint W2 a specific combination of various sensor values is to be expected, and if the measurement data corresponds with those expectations, the waypoint W2 is obtained.

In an example embodiment, also illustrated in FIG. 10, the specific geographic location of the waypoint W1 is generated by a user interface operation 1002 coupled with the mobile apparatus 210 on a spatial at least two-dimensional map 600.

In an example embodiment, the waypoint is generated automatically as a response to the measurement data meeting a predetermined condition. With this example embodiment, the generation of the waypoint is done automatically, without any user interface operation. In an auxiliary or alternative example embodiment, the waypoint is obtained by accepting an automatic user interface suggestion 1002 coupled with the mobile apparatus 210. In a further example embodiment, the automatic user interface suggestion 1002 is based on at least one distance between obtained previous waypoints and an estimated location of the mobile apparatus 210.

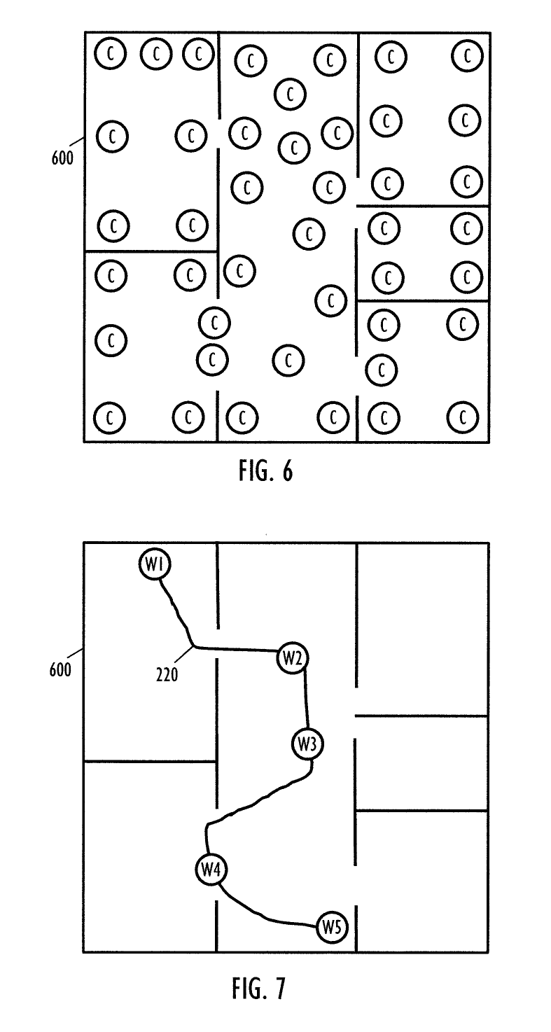

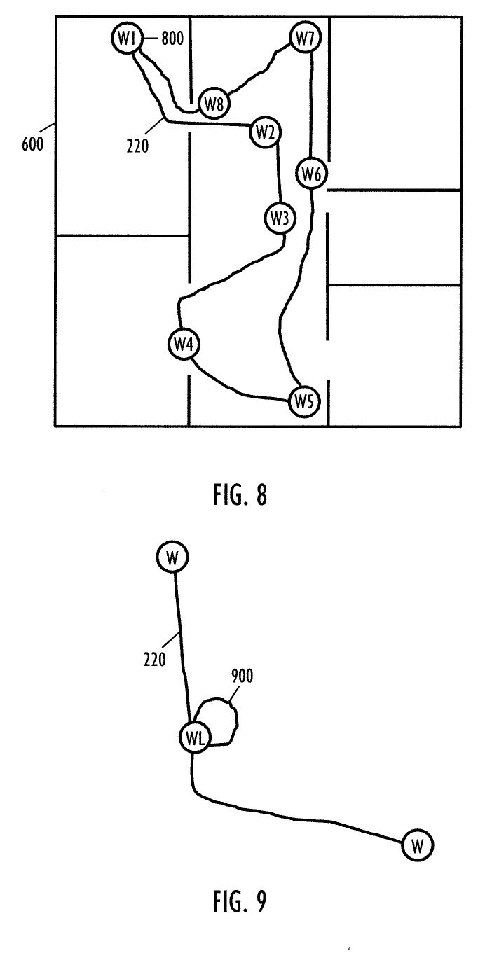

In an example embodiment illustrated in FIG. 8, the specific geographic location 800 of the waypoint is another, previously during the known time period obtained waypoint W1 that is being revisited, whereby a loop closure is recognized for the dead reckoning. Note that in FIG. 8 the total number of the waypoints is also increased: W1, W2, W3, W4, W5, W6, W7, W8, and then again W1 800. In a further example embodiment, the other previously obtained waypoint W1 is generated in the mobile apparatus 210 with a computer vision, and the newly obtained waypoint 800 is recognized as the same as the other previously obtained waypoint W1 with the computer vision. In its simplest form, this may be implemented so that the mobile apparatus 210 comprises a camera (with lenses and possible lighting) to acquire a first (2D visible light, for example) image of surroundings of W1, and later a second image is obtained from surroundings, after which suitable digital image processing techniques are used to extract the required information from the first and second images in order to make a decision that the same location W1, 800 is revisited. Naturally, the loop closures may also be recognized with other ways, as explained for the waypoint recognition elsewhere (RF, camera, etc.), for example.

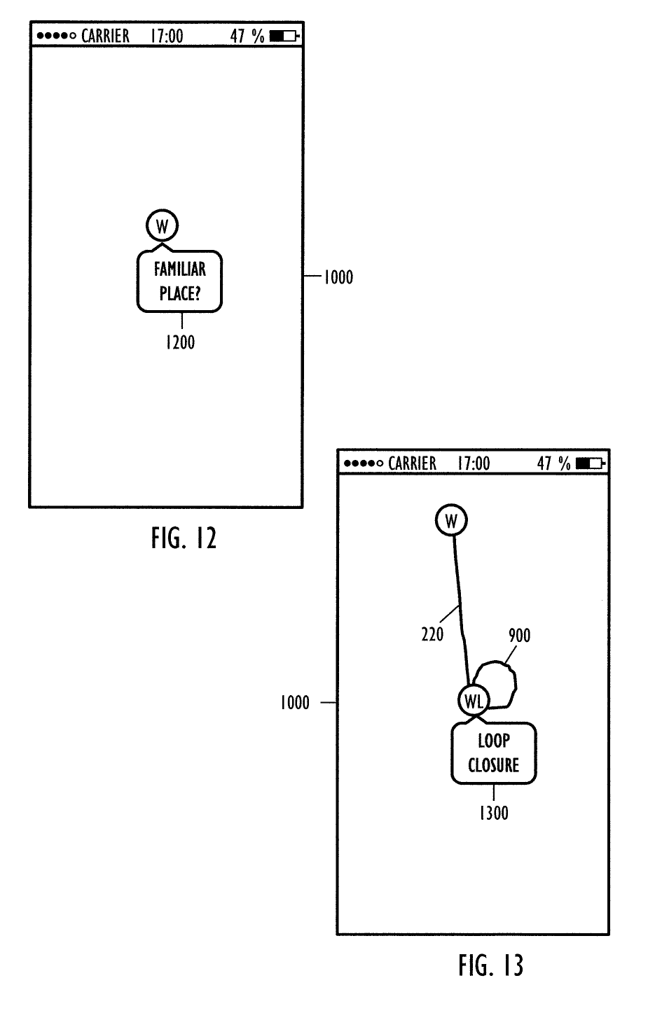

In an example embodiment illustrated in FIG. 12, a user interface operation 1200 coupled with the mobile apparatus 210 indicates a return to another, previously obtained waypoint W.

In an example embodiment illustrated in FIGS. 9 and 13, a loop begin waypoint is marked with a user interface operation coupled with the mobile apparatus 210, and a loop end waypoint is marked with a user interface operation 1300 coupled with the mobile apparatus 210, whereby a loop closure 900 is recognized (the loop closure may be utilized for the dead reckoning).

In an example embodiment, the event obtainment 112 is performed so that the event E1-E5 is generated in the mobile apparatus 210 during the known time period T0-TF in real-time or near real-time.

In an alternative example embodiment, the event obtainment 112 is performed so that the event E1-E5 is generated in the processing apparatus 100 after the known time period T0-TF as post-processing.

In an example embodiment, the processing apparatus 100 is further caused to perform the construction 114 of the spatial path 220 with a first accuracy in real-time with a first amount of processing power of the one or more processors 102, and perform the construction 114 of the spatial path 220 with a second accuracy as post-processing with a second amount of processing power of the one or more processors 102. The second accuracy is more accurate than the first accuracy, and the second amount of the processing power is greater than the first amount of the processing power. With this example embodiment, the accuracy of the path 220 construction 114 may be varied depending on the situation as the path 220 may be constructed 114 twice: first in real-time, and later as processing. For example: the path 220 may be constructed 114 in real-time with less accuracy in order to save the processing power and, consequently, in order to save the electric power consumed by the processing apparatus 100. Later, when processing power need not be saved, the path 220 may be constructed 114 with higher accuracy. For example: the first accuracy may define the positions of the path 220 with one meter accuracy, whereas the second accuracy may define the positions of the path 220 with an accuracy of ten centimeters (=0.1 meter), i.e., ten times more accurate. The (first and second) accuracy may be adjusted based on the complexity of the algorithm, the number of candidate spatial paths, etc. Besides the processing power, also the memory 104 usage may be adjusted based on the (first or second) accuracy.

In an example embodiment, the construction 114 of the spatial path 220 in the real-time utilizes the first amount of the processing power of the one or more processors 102A of the mobile apparatus 210, and the construction of the spatial path as the post-processing utilizes the second amount of the processing power of the one or more processors 102B of the computing resource 310, which is communicatively couplable with the mobile apparatus 210. With this example embodiment, the battery of the mobile apparatus 210 may be saved as less electricity is consumer by the processor(s) 102A. The computing resource 310 may comprise a large number of distributed processors 102B so that the post-processing may comprise massive calculations (as compared to the relatively restrained processing in the mobile apparatus 210).

In an example embodiment, the spatial path 220 constructed 114 in real-time may be shown in the user interface 418 of the mobile apparatus 210 (or as a user interface operation coupled with the mobile apparatus 210, with smartglasses 304, for example) in real-time, whereas the spatial path 220 constructed 114 as post-processing may be shown later, if desired. This example embodiment may also be combined with the example embodiment, discussed elsewhere, with which a prediction of the current position of the mobile apparatus 210 is shown in real-time with a user interface operation coupled with the mobile apparatus 210.

In an example embodiment, the measurement data T0(S1, . . . , SN)-TF(S1, . . . , SN) is obtained 110 from the mobile apparatus 210 wandering with a random route and with a varying speed.

In an example embodiment, the spatial path 220 is reconstructed 114 every time after a new event is obtained 112. In a further example embodiment, the measurement data T0(S1, . . . , SN)-TF(S1, . . . , SN) is reassociated 116 with the spatial path 220 every time after the spatial path 220 is reconstructed 114.

In an example embodiment, the spatial path 220 is mapped into at least one of the following: a world coordinate system, a coordinate system, a map, a floor plan.

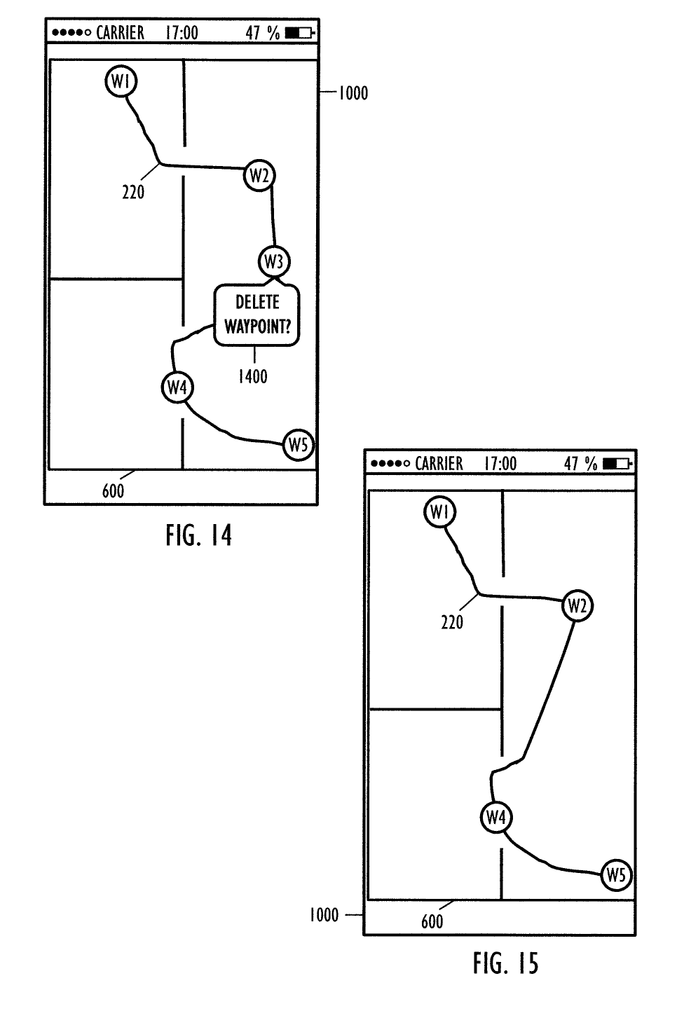

In an example embodiment illustrated in FIGS. 14 and 15, the processing apparatus 100 is further caused to: obtain a deletion of an event (in our example embodiment waypoint W3) from a user interface operation 1400 coupled with the mobile apparatus 210; reconstruct 114 the spatial path 220 of the mobile apparatus 210 taking into account the deleted event (waypoint W3); and reassociate 116 the measurement data T0(S1, . . . , SN)-TF(S1, . . . , SN) with the spatial path 220.

In an alternative example embodiment, the processing apparatus 100 is further caused to: delete an event (waypoint W3) based on an analysis showing that the event (waypoint W3) does not match with the measurement data T0(S1, . . . , SN)-TF(S1, . . . , SN); reconstruct 114 the spatial path 220 of the mobile apparatus 210 taking into account the deleted event (waypoint W3); and reassociate 116 the measurement data T0(S1, . . . , SN)-TF(S1, . . . , SN) with the spatial path 220.

In an example embodiment, the processing apparatus 100 is further caused to generate a spatial measurement data map for a positioning procedure by utilizing the association of the measurement data T0(S1, . . . , SN)-TF(S1, . . . , SN) with the spatial path 220. With this example embodiment, the collected measurement data T0(S1, . . . , SN)-TF(S1, . . . , SN) may be utilized for building a map, a magnetic positioning data map, for example. In the magnetic positioning of the mobile apparatus 210, each magnetic vector measured by the mobile apparatus 210 carried by a person may be compared to existing information, wherein the information may comprise magnetic vector strength and direction in several locations within a building or within a plurality of buildings. The information may thus depict an indoor magnetic field map. As implied by the word “map”, the magnetic field map comprises location specific data: each location in the map is associated with a certain magnetic field value (magnitude and/or direction), for example.

One problem related to the positioning technique based on the magnetic field is that the generation of the magnetic field map needs extensive work from the mappers, i.e., from persons who travel within the building and collect the magnetic field vector values, in a crowd sourcing fashion, for example. There is an enormous number of buildings and other man-made structures for which the magnetic field map needs to be generated worldwide. Therefore, ordinary people using a magnetometer, e.g. during an execution of an magnetic field based location tracking software/application, in their mobile apparatuses 210 may contribute to the generation of the magnetic field map. Such mapping technique may be called simultaneous localization and mapping (SLAM). In the proposed SLAM, persons build up the magnetic field map in an indoor environment (without a priori knowledge of the magnetic field map), or update the already existing magnetic field map within a known environment (with a priori knowledge of the current magnetic field map). In an example embodiment, the mappers may, at the same time, at least try to keep track of their current location on the basis of the measured magnetic field values.

In an example embodiment, the processing apparatus 100 is further caused to visualize the spatial measurement data map with a color coding to indicate a quality of the spatial measurement data map. For example, those parts with inferior quality are colored with red, those parts still needing improvement with yellow, and those parts with good quality with green. The quality may be determined for specific areas (=collection of individual points) or even to specific points (determined with x and y coordinates, for example)

In an example embodiment, the processing apparatus 100 is further caused to: calculate a prediction of a current position of the mobile apparatus 210 based on the constructed spatial path 220 and an elimination of a processing delay in the construction of the spatial path 220; and show the current position in real-time by a user interface operation coupled with the mobile apparatus 210. With this example embodiment, the user of the mobile apparatus 210 will see his/her current position instead of some previous position. FIG. 11 illustrates this: the spatial path 220 is shown in real-time, and the predicted current position is in waypoint W2. Without this example embodiment, the processing delay could cause that the current position were shown to be in position 1102, for example.

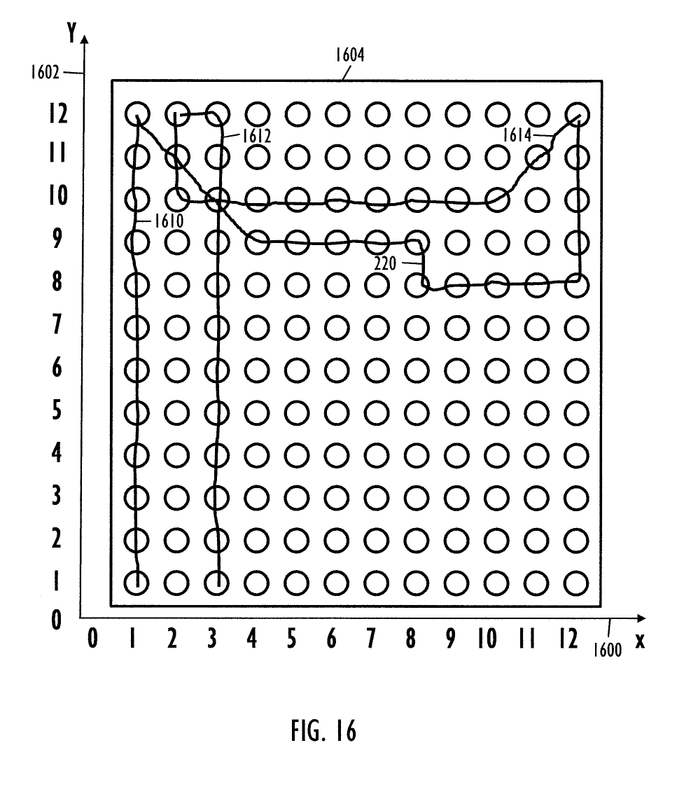

In an example embodiment illustrated in FIG. 16, the processing apparatus 100 is further caused to: obtain measurement data generated by another mobile apparatus; and construct the spatial path of the mobile apparatus based also on the measurement data generated by the other mobile apparatus. In our example embodiment, let us suppose that the mobile apparatus 210 has travelled along the spatial path 220, and the other mobile apparatuses have travelled along the spatial paths 1610, 1612 and 1614. As can be seen from FIG. 16, the spatial paths 220, 1610, 1612, 1614, 1614 have been mapped to two dimensions, x axis 1600 and y axis 1602, and possibly also to a map 1604. The mobile apparatus 210 may utilize at least the information from the other mobile apparatuses in locations (X1, Y12), (X2, Y11), (X3, Y10) and (X12, Y12). Alternatively, or additionally, the event E1-E5 may also be based on data obtained from another mobile apparatus. For example: a specific waypoint W has earlier been obtained by another mobile apparatus, and the present obtainment 112 of that same waypoint 112 may be based on the earlier obtainment.

In an example embodiment also illustrated in FIG. 16, the processing apparatus 100 is further caused to: if the specific point of the spatial path matches with a position on a measurement data map, associate the measurement sample, associated with the specific point, with the position on the measurement data map. With this example embodiment, there is a predetermined measurement data map 1604, the coordinates X, Y indicating a plurality (12×12=144) of data cells. First, these data cells may be empty, but as mobile apparatuses 210 gather measurement data T0(S1, . . . , SN)-TF(S1, . . . , SN) it is placed into the data cells. In this way, the spatial paths 220, 1610, 1612, 1614, 1616 collect the measurement data, T0(S1, . . . , SN)-TF(S1, . . . , SN), which is placed into the measurement data map 1604, or into a data structure such as a table (in our example embodiment with 144 data cells each capable of storing the measurement samples from various sensors S1-SN.

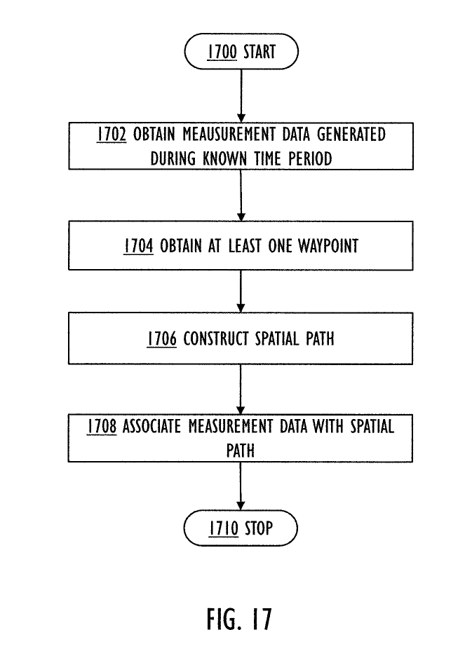

Next, let us study FIG. 17 illustrating a method performed in the processing apparatus 100. The operations are not strictly in chronological order, and some of the operations may be performed simultaneously or in an order differing from the given ones. Other functions may also be executed between the operations or within the operations and other data exchanged between the operations. Some of the operations or part of the operations may also be left out or replaced by a corresponding operation or part of the operation. It should be noted that no special order of operations is required, except where necessary due to the logical requirements for the processing order.

The method starts in 1700.

In 1702, measurement data generated by a mobile apparatus with one or more sensors during a known time period is obtained, the measurement data comprising a plurality of measurement samples and timing data indicating timing of measurement samples in relation to each other.

In 1704 at least one event related to the mobile apparatus is obtained, the event being associated with the measurement data so that it represents a specific time and/or a specific location during the known time period.

In 1706, a spatial path of the mobile apparatus is constructed based on at least a part of the measurement data and the at least one event.

In 1708, the measurement data is associated with the spatial path so that a measurement sample is associated with a specific point of the spatial path.

The method ends in 1610.

The already described example embodiments of the processing apparatus 100 may be utilized to enhance the method with various further example embodiments. For example, various structural and/or operational details may supplement the method.

It will be obvious to a person skilled in the art that, as technology advances, the inventive concept can be implemented in various ways. The invention and its embodiments are not limited to the example embodiments described above but may vary within the scope of the claims.

1-42. (canceled)

43. A processing apparatus comprising:
one or more processors; and
one or more memories including computer program code,
the one or more memories and the computer program code configured to, with the one or more processors, cause the processing apparatus at least to:
obtain measurement data generated by a mobile apparatus with one or more sensors during a known time period, the measurement data comprising a plurality of measurement samples and timing data indicating timing of measurement samples in relation to each other;
obtain at least one event related to the mobile apparatus, the event being associated with the measurement data so that it represents a specific time and/or a specific location during the known time period;
construct a spatial path of the mobile apparatus based on at least a part of the measurement data and the at least one event; and
associate the measurement data with the spatial path so that a measurement sample is associated with a specific point of the spatial path.

44. The processing apparatus of claim 43, wherein the measurement data comprises at least one of the following: inertial sensor data, magnetometer data, indoor base station data, cellular network data, wireless access point data, WiFi data, Bluetooth radio data, air pressure data, illumination data, audio data, video data, camera data, temperature data, barometer data, altitude data, range sensor data, indoor positioning data, global navigation satellite system data, smell sensor data, air quality sensor data, radar data, data generated by an internal sensor of the mobile apparatus, data generated by a sensor external to the mobile apparatus.

45. The processing apparatus of claim 43, wherein the measurement data comprises inertial measurement data comprising at least one of the following: motion sensor data, acceleration sensor data, angular velocity data, stride information data.

46. The processing apparatus of claim 43, wherein the measurement data comprises successive measurement samples of magnetic field, and the measurement data is associated with the spatial path so that the successive measurement samples of magnetic field are associated with successive specific points of the spatial path.

47. The processing apparatus of claim 46, wherein the measurement data comprises other sensor data besides the magnetic field, and at least a part of the other sensor data is utilized in the construction of the spatial path.

48. The processing apparatus of claim 43, wherein the at least one event related to the mobile apparatus further comprises at least one of a speed of the mobile apparatus, a heading of the mobile apparatus, a loop closure of the spatial path.

49. The processing apparatus of claim 43, wherein the at least one event related to the mobile apparatus further comprises a waypoint with a set of coordinates determining the specific location.

50. The processing apparatus of claim 49, wherein the waypoint is generated during the known time period by a user interface operation coupled with the mobile apparatus.

51. The processing apparatus of claim 49, wherein the specific geographic location of the waypoint is generated by a user interface operation coupled with the mobile apparatus on a spatial at least two-dimensional map.

52. The processing apparatus of claim 49, wherein the specific geographic location of the waypoint is another, previously during the known time period obtained waypoint that is being revisited, whereby a loop closure is recognized.

53. The processing apparatus of claim 52, wherein the other previously obtained waypoint is generated in the mobile apparatus with a computer vision, and the newly obtained waypoint is recognized as the same as the other previously obtained waypoint with the computer vision.

54. The processing apparatus of claim 43, wherein the spatial path is reconstructed every time after a new event is obtained.

55. The processing apparatus of claim 43, wherein the spatial path is mapped into at least one of the following: a world coordinate system, a coordinate system, a map, a floor plan.

56. The processing apparatus of claim 43, further caused to:
generate a spatial measurement data map for a positioning procedure by utilizing the association of the measurement data with the spatial path.

57. The processing apparatus of claim 56, further caused to:
visualize the spatial measurement data map with a color coding to indicate a quality of the spatial measurement data map.

58. The processing apparatus of claim 43, further caused to:
calculate a prediction of a current position of the mobile apparatus based on the constructed spatial path and an elimination of a processing delay in the construction of the spatial path; and
show the current position in real-time by a user interface operation coupled with the mobile apparatus.

59. The processing apparatus of claim 43, further caused to:
obtain measurement data generated by another mobile apparatus; and
construct the spatial path of the mobile apparatus based also on the measurement data generated by the other mobile apparatus.

60. The processing apparatus of claim 43, further caused to:
if the specific point of the spatial path matches with a position on a measurement data map, associate the measurement sample, associated with the specific point, with the position on the measurement data map.

61. A non-transitory computer-readable storage medium comprising computer program code which, when loaded into a processing apparatus causes the processing apparatus at least to:
obtain measurement data generated by a mobile apparatus with one or more sensors during a known time period, the measurement data comprising a plurality of measurement samples and timing data indicating timing of measurement samples in relation to each other;
obtain at least one event related to the mobile apparatus, the event being associated with the measurement data so that it represents a specific time and/or a specific location during the known time period;
construct a spatial path of the mobile apparatus based on at least a part of the measurement data and the at least one event; and
associate the measurement data with the spatial path so that a measurement sample is associated with a specific point of the spatial path.

62. A method in a processing apparatus, comprising:
obtaining measurement data generated by a mobile apparatus with one or more sensors during a known time period, the measurement data comprising a plurality of measurement samples and timing data indicating timing of measurement samples in relation to each other;
obtaining at least one event related to the mobile apparatus, the event being associated with the measurement data so that it represents a specific time and/or a specific location during the known time period;
constructing a spatial path of the mobile apparatus based on at least a part of the measurement data and the at least one event; and
associating the measurement data with the spatial path so that a measurement sample is associated with a specific point of the spatial path.
